(19) United States
(12) Patent Application Publication
(10) Pub. No.: US 2017/0073819 A1
(43) Pub. Date: Mar. 16, 2017

(54) CERAMIC THERMAL BARRIER COATING SYSTEM COMPRISING A LAYER PROTECTING AGAINST CMAS

(71) Applicant: Siemens Aktiengesellschaft, München (DE)

(72) Inventors: ALEXANDER RÖTZHEIM, MÜLHEIM/RUHR (DE); WERNER STAMM, MÜLHEIM AN DER RUHR (DE)

(73) Assignee: Siemens Aktiegesellschaft, Munchen (DE)

(21) Appl. No.: 15/125,202

(22) PCT Filed: Mar. 5, 2015
(86) PCT No.: PCT/EP2015/054601

§ 371 Date: Sep. 12, 2016

(30) Foreign Application Priority Data
Mar. 25, 2014 (DE) 102014205491.5

(51) Int. Cl. C23C 28/00; C04B 37/02

(52) U.S. Cl. CPC C23C 28/322; C23C 28/345; C23C 28/3455; C04B 37/026; C04B 2237/123; C04B 2237/348

(57) ABSTRACT

The application relates to a ceramic coating system for thermal insulation which contains further layers for protecting against the penetration of CMAS. The application of two additional layers which consist/comprise of platinum titanium oxide, magnesium aluminate or iron aluminate and an outer aluminum or aluminum oxide layer to a ceramic layer system, thereby sufficiently protecting same from CMAS attacks at higher temperatures is provided.

### CROSS-REFERENCE TO RELATED APPLICATIONS

This application claims priority to PCT Application No. PCT/EP2015/054601, having a filing date of Mar. 5, 2015, based off of DE Application No. 10 2014 205 491.5 having a filing date of Mar. 25, 2014, the entire contents of which are hereby incorporated by reference.

### FIELD OF TECHNOLOGY

The following relates to a ceramic coating system for thermal insulation which contains further layers for protecting against the penetration of CMAS.

### BACKGROUND

A hot gas path of a gas turbine contains components which are coated with thermal barrier coatings consisting/comprising of partially stabilized zirconium and/or gadolinium zirconate in order to lower the metal temperature. The present-day surface temperatures of the ceramics in combination with impurities such as CMAS lead to chemical attacks on the ceramics and also to the penetration of liquid phases into the pores of the ceramic. At the same time, the abrasion of the compressor abradables of an upstream compressor leads to unique nickel coatings on the layers. This too leads to instances of TBC spalling as a result of reduced thermal expansions. At present, there is no system protecting against this multiple attack.

### SUMMARY

An aspect relates to a coating system which solves the aforementioned problem.

### BRIEF DESCRIPTION

Some of the embodiments will be described in detail, with reference to the following figures, wherein like designations denote like members, wherein:

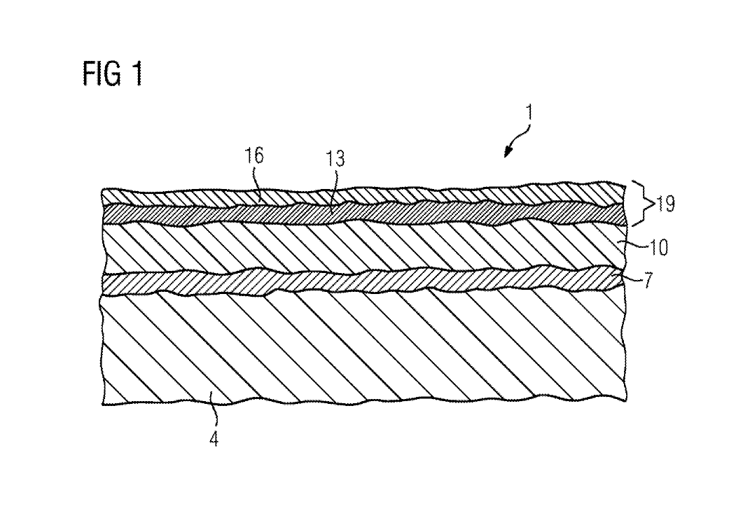

FIG. 1 shows a coating system, and

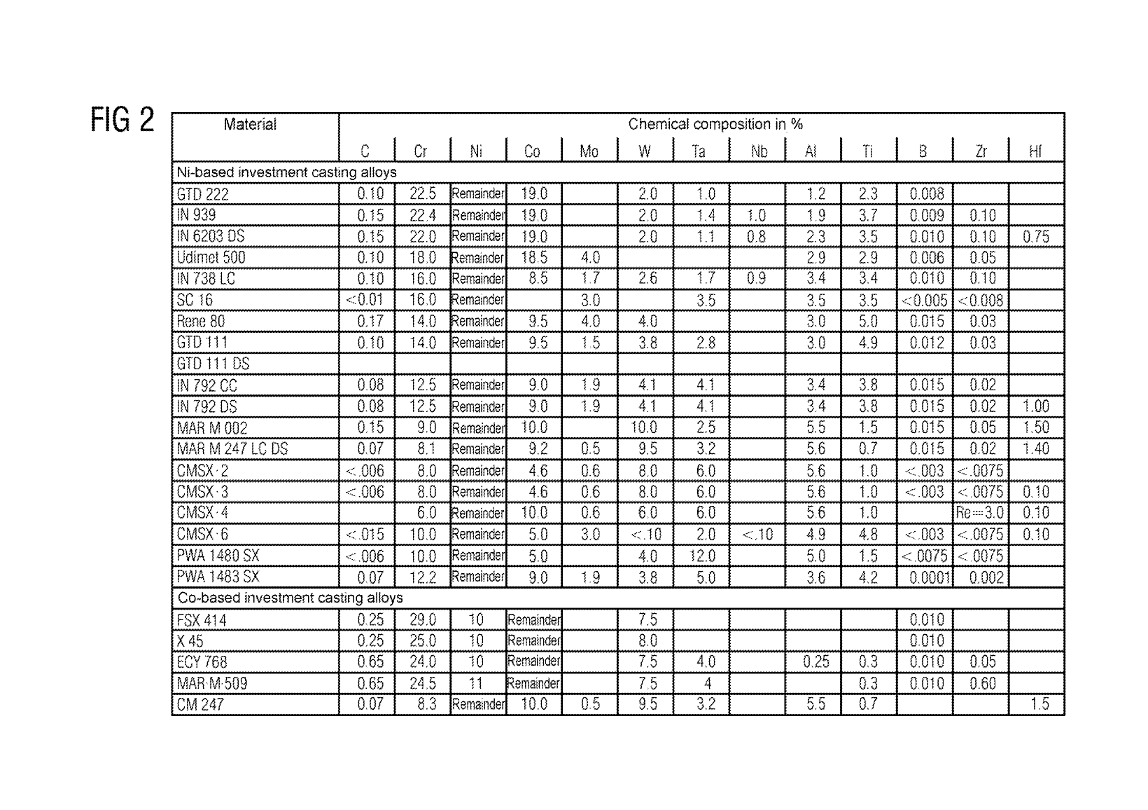

FIG. 2 shows a list of superalloys.

### DETAILED DESCRIPTION

The figure and the description represent only exemplary embodiments of the invention.

A platinum layer is preferably applied to a thermal barrier layer 10 as a lower erosion-resistant layer 13.

This lower erosion-resistant layer 13 is to prevent the penetration of the CMAS (CMAF) layer.

The coating can be effected by vapor deposition, sputtering. This lower erosion-resistant layer 13 can have a layer thickness of between several um and 100 μm.

Furthermore, a layer consisting of aluminum particles, preferably with a thickness of 50 μm to 300 μm, is applied to said lower erosion-resistant layer 13.

Hollow balls of aluminum oxide are formed by a preferable heat treatment of the aluminum layer. At the same time, the balls bind to the platinum through the formation of platinum aluminide. The platinum has a coefficient of expansion adapted to the thermal barrier layer.

Applied aluminum oxide has a relatively low coefficient of expansion, and, in combination with the nickel (originates from the compressor abrasion), the aluminum oxide spalls off. The remaining platinum layer then affords protection against the penetration of liquid deposits. The platinum layer can preferably also be replaced by titanium oxide or Mg₂AlO₄ and/or Fe₂AlO₄.

The inventive step is based on the application of the multiple layer, which affords protection both against nickel deposits and against CMAS. Since the nickel deposits arise only briefly and at the start of the operating time, what is formed is a layer which acts briefly here and has a layer with long-term action against CMAS or similar attacks.

FIG. 1 shows a coating system 1 according to embodiments of the invention comprising a substrate 4.

Particularly in the case of turbine components, the substrate 4 is a nickel-based or cobalt-based superalloy, in particular as shown in FIG. 2.

Various metallic bonding layers 7 may be present on the substrate 4.

Here, what is involved is preferably an overlay layer consisting of an alloy of the MCrAlX type, where X is optional and in particular is yttrium (Y), rhenium (Re) and/or tantalum (Ta) and/or iron (Fe).

An oxide layer has already grown (TGO aluminum oxide, not shown) on the metallic bonding layer 7, and a further ceramic thermal barrier layer material 10 is present on said oxide layer.

This ceramic thermal barrier layer material 10 can be a zirconium oxide layer with various stabilizers and/or a pyrochlore structure or else a two-ply or multi-ply TBC, in particular an inner zirconium oxide layer with an outer pyrochlore structural layer, in particular gadolinium zirconate (GZO).

Such coating systems are known and, according to embodiments of the invention, additionally comprise a lower erosion-resistant layer 13 consisting of platinum, titanium oxide, magnesium aluminate (Mg₂AlO₄) or iron aluminate (Fe₂AlO₄).

Mixtures thereof can be used.

The outermost erosion-resistant layer 16 comprises aluminum or aluminum oxide.

Mixtures thereof can be used.

Examples of a material sequence of the system:
Substrate -MCrAlX—ZrO₂_{_}Mg₂AlO₄_{_}Al
Substrate -MCrAlX—ZrO₂_{_}Fe₂AlO₄_{_}Al
Substrate -MCrAlX—ZrO₂—Pt—Al
Substrate -MCrAlX—ZrO₂_{_}GZO—Mg₂AlO₄_{_}Al
Substrate -MCrAlX—ZrO₂_{_}GZO—Fe₂AlO₄_{_}Al
Substrate -MCrAlX—ZrO₂-GZO—Pt_Al
Substrate -MCrAlX—ZrO₂—Mg₂AlO₄_{_}Al₂O₃
Substrate -MCrAlX—ZrO₂_{_}Fe₂AlO₄—Al₂O₃
Substrate -MCrAlX—ZrO₂_{_}Pt_Al₂O₃
Substrate -MCrAlX—ZrO₂_{_}GZO—Mg₂AlO₄_{_}Al₂O₃
Substrate -MCrAlX—ZrO₂_{_}GZO—Fe₂AlO₄—Al₂O₃
Substrate -MCrAlX—ZrO₂_{_}GZO—Pt—Al₂O₃

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A ceramic thermal barrier coating system, which comprises at least: a substrate,
of a nickel-based or cobalt-based superalloy,
a metallic adhesion promoter layer,
of the MCrAlX type, where X=Y, Re, Ta, or Fe,
a ceramic thermal barrier layer,
a two-ply erosion-resistant layer,
which is applied directly to the ceramic thermal barrier layer, and
in which a material selected from the group consisting of platinum, titanium oxide, magnesium aluminate and iron aluminate is selected for the lower erosion-resistant layer, and
wherein at least one of aluminum and aluminum oxide is applied directly to the lower erosion-resistant layer as the outermost erosion-resistant layer.

2. The coating system as claimed in claim 1, in which the metallic adhesion promoter layer represents an overlay layer of the composition MCrAlX, including NiCoCrAlY, NiCoCrAlTa, NiCoCrAlYTa, NiCoCrAlYRe or NiCoCrAlRe.

3. The coating system as claimed in claim 1, in which the ceramic thermal barrier layer has the greatest layer thickness of the four layers is 10% thicker.

4. The coating system as claimed in claim 1, in which the ceramic thermal barrier layer comprises a single-ply zirconium oxide layer.

5. The coating system as claimed in claim 1, in which the ceramic thermal barrier layer represents a two-ply ceramic layer comprising
a lower zirconium oxide layer
and an outer pyrochlore layer,
having a gadolinium zirconate layer.

6. The coating system as claimed in claim 1, in which the lower erosion-resistant layer has a thickness of 2 μm to 200 μm.

7. The coating system as claimed in claim 1, in which the outermost erosion-resistant layer has a thickness of 50 μm to 300 μm.

8. The coating system as claimed in claim 1, in which the outer erosion-resistant layer comprises aluminum and has hollow balls as a result of a heat treatment.
